(19) United States
(12) Patent Application Publication
(10) Pub. No.: US 2025/0297738 A1
(43) Pub. Date: Sep. 25, 2025

(54) Intelligent Candle System

(71) Applicant: Guangen Xiang, Lake Forest, CA (US)

(72) Inventor: Guangen Xiang, Lake Forest, CA (US)

(73) Assignee: Alyax, LLC, Lake Forest, CA (US)

(21) Appl. No.: 18/611,201

(22) Filed: Mar. 20, 2024

(51) Int. Cl. F23Q 3/00; F21V 37/00; F23Q 25/00; H05B 47/11; H05B 47/13; H05B 47/175

(52) U.S. Cl. CPC F23Q 3/006; F21V 37/002; F21V 37/005; F23Q 25/00; H05B 47/11; H05B 47/13; H05B 47/175

(57) ABSTRACT

An automatic ignition and extinguishing candle comprising a candle body with one or two wicks, an electric arc lighter or arc generating circuit for ignition, a fan-based air blower for extinguishing, and a motion sensor for triggering the extinguishing. The single wick version utilizes an electric arc lighter with two electrodes positioned beside the wick, while the two-wick design employs wicks made of combustible and electrically conductive materials, allowing the wicks themselves to serve as electrodes for arc generation. The motion sensor detects nearby motion and activates the air blower to extinguish the flame. Additional features may include a microcontroller for overall control, manual ignition and timed extinguishing capabilities, remote control operation, sound and light sensors for automatic ignition, and specific wick structures and conductive coatings. This invention provides a safe, convenient, and automated way to control the ignition and extinguishing of candles.

### FIELD OF THE DISCLOSURE

The present invention relates to the field of candle technology, specifically focusing on the development of an innovative automatic ignition and extinguishing candle. The invention encompasses advancements in candle safety, convenience, and user experience by incorporating advanced ignition mechanisms, motion-activated extinguishing features, and smart control capabilities. The candle's design aims to revolutionize the way people interact with and enjoy candles in various settings.

### BACKGROUND OF THE INVENTION

Candles have been a traditional source of light and ambiance for centuries, and their basic design has remained largely unchanged. However, with the advent of modern technology, there has been a growing interest in developing candles with enhanced features and improved safety. Conventional candles require manual ignition, typically with matches or lighters, which can be inconvenient and pose a fire hazard, especially if left unattended. Additionally, traditional candles lack the ability to be extinguished automatically, requiring users to monitor the candle closely and manually extinguish the flame when desired.

In recent years, various attempts have been made to address these limitations. For example, some candles incorporate a wick-trimming mechanism to control the size of the flame and prevent excessive smoke and soot production. Others have introduced fragrances and colors to enhance the sensory experience. However, these improvements do not address the fundamental issues of manual ignition and extinguishing.

Some prior art, have proposed automatic ignition mechanisms for candles using electric arc lighters or arc generating circuits. These designs aim to provide a more convenient and safer way to light the candle. However, they still lack the ability to automatically extinguish the flame when desired or in case of emergencies.

Moreover, existing automatic ignition candles do not offer a comprehensive solution that integrates user-friendly controls, timed extinguishing, remote operation, and additional safety features such as motion, sound, or light sensors. The absence of these features limits the versatility and practicality of the candles in various settings and situations.

Therefore, there is a need for an improved automatic ignition and extinguishing candle that addresses the shortcomings of prior art and provides a safe, convenient, and feature-rich solution for users. The object of the present invention is to develop an intelligent candle that incorporates advanced ignition and extinguishing mechanisms, as well as a range of user-friendly features and safety enhancements, to revolutionize the way people experience and interact with candles in their daily lives.

### SUMMARY

The following summary provides an overview of some of the key inventive features of the automatic ignition and extinguishing candle. This summary is not an extensive overview of the invention and is not intended to identify all key or critical elements of the invention or to delineate the scope of the invention. Its sole purpose is to present some concepts of the invention in a simplified form as a prelude to the more detailed description that is presented later.

The present invention relates to an automatic ignition and extinguishing candle that provides a safe, convenient, and feature-rich solution for candle users. The candle comprises a candle body containing a wax fuel and either one or two wicks. In the single-wick embodiment, an electric arc lighter with two electrodes is positioned adjacent to the wick, while in the two-wick embodiment, the wicks are made of combustible and electrically conductive materials, allowing them to function as electrodes for arc generation.

A fan-based air blower is positioned to direct an airflow at the wick(s) for efficient flame extinguishing. The candle further comprises a motion sensor configured to detect nearby motion and trigger the air blower to automatically extinguish the flame when necessary. This feature enhances safety, particularly when the candle is left unattended or forgotten.

The candle may also include a microcontroller that controls the operation of the electric arc lighter or arc generating circuit and the fan-based air blower. This enables the implementation of additional features such as manual ignition, timed extinguishing, and remote control operation, providing users with increased flexibility and convenience in controlling the candle's functionality.

Furthermore, the invention contemplates the integration of sound and light sensors, allowing the candle to automatically ignite in response to specific auditory or ambient light cues. This feature adds innovation and practicality, making the candle suitable for various settings and occasions.

The single-wick embodiment, with its electric arc lighter and strategically placed electrodes, ensures reliable and efficient ignition. The two-wick embodiment, featuring conductive materials, allows the wicks to serve as electrodes for arc generation. The fan-based air blower, triggered by the motion sensor, automatically extinguishes the flame when needed, enhancing safety. The microcontroller enables manual ignition, timed extinguishing, remote control operation, and integration of sound and light sensors.

### BRIEF DESCRIPTION OF THE DRAWING

FIG. 1 depicts a single wick candle with the wick disposed between two electrodes for ignition.

FIG. 2 illustrates an air hole connecting the fan to blow out the flame

FIG. 3 depicts a disassembled single wick candle system in one aspect.

FIG. 4 depicts a double wick candle with, wicks being coated in a conductive layer to function as electrodes for self-ignition.

FIG. 5 depicts a disassembled double candle system in one aspect.

### DETAILED DESCRIPTION OF THE INVENTION

As used herein, the terms “comprising,” “including,” “containing,” “characterized by,” and grammatical equivalents thereof are inclusive or open-ended and do not exclude additional, unrecited elements or method steps, unless otherwise stated. Other than in the operating examples, or where otherwise indicated, all numbers expressing measurements, dimensions, and so forth used in the specification and claims are to be understood as being modified in all instances by the term “about,” meaning within a reasonable range of the indicated value.

The present invention provides a novel automatic ignition and extinguishing candle aimed at improving safety, convenience, and user experience. The inventive candle comprises specific structural elements and features arranged in a defined configuration, designed to address the limitations of existing candle ignition and extinguishing mechanisms. The following detailed description discloses various embodiments, aspects, and features of the present invention, which are not intended to limit the scope of the invention in any way but rather to exemplify the preferred embodiments.

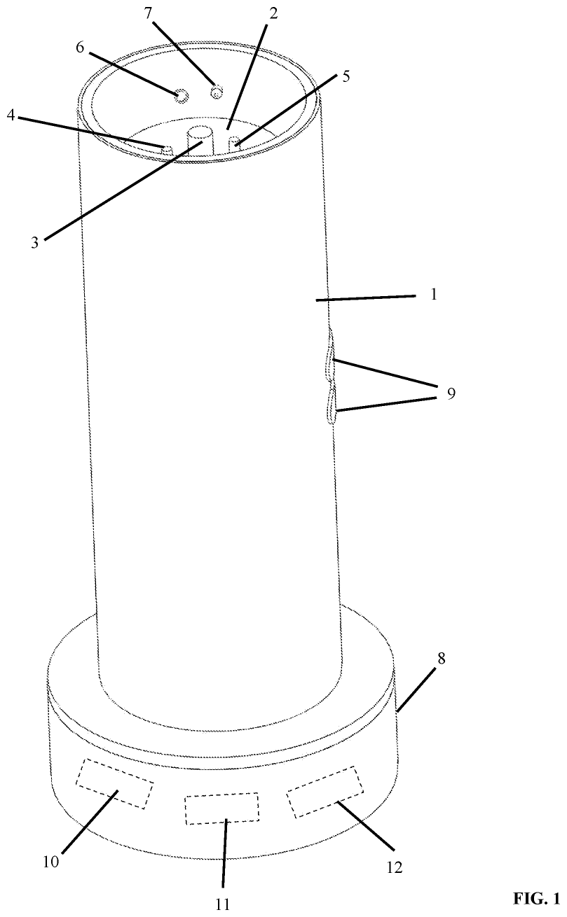

The embodiment of FIG. 1 illustrates a perspective view of a single wick automatic ignition and extinguishing candle according to an aspect of the present invention. The candle comprises a candle body (1) designed to contain and support the candle wax (2) and the wick (3). The candle body (1) is preferably made of a heat-resistant material, such as glass, ceramic, or metal, to ensure durability and safety during use.

Disposed within the candle wax (2) is a single wick (3), which is positioned between a first electrode (4) and a second electrode (5). The electrodes (4, 5) are connected to a power source, such as a battery (12), and are configured to generate an electric arc between them to ignite the wick (3) when the candle is activated.

The candle body (1) also features an air hole (6) strategically located to direct air towards the wick (3) to extinguish the flame when necessary. The air flow is generated by a fan (11) housed within the base (8) of the candle. The fan (11) is activated by a controller (10) in response to signals received from a sensor (7), such as an infrared (IR) sensor, which detects motion or presence near the candle.

The base (8) of the candle houses the electronic components, including the controller (10), battery (12), and fan (11). The battery (12) may be a rechargeable or disposable battery, a capacitor, or the candle may be powered through a wired connection. The candle body (1) or base (8) may also includes buttons (9) that allow the user to manually control the ignition and extinguishing of the candle, as well as other functions such as setting timers or adjusting the sensitivity of the sensor (7).

In operation, when the user presses the appropriate button (9), the controller (10) initiates the ignition sequence by sending a signal to the electrodes (4, 5) to generate an electric arc, which ignites the wick (3). The candle will continue to burn until the sensor (7) detects motion or presence near the candle, at which point the controller (10) activates the fan (11) to direct air through the air hole (6) and extinguish the flame. The user can also manually extinguish the candle by pressing the designated button (9) on the base (8).

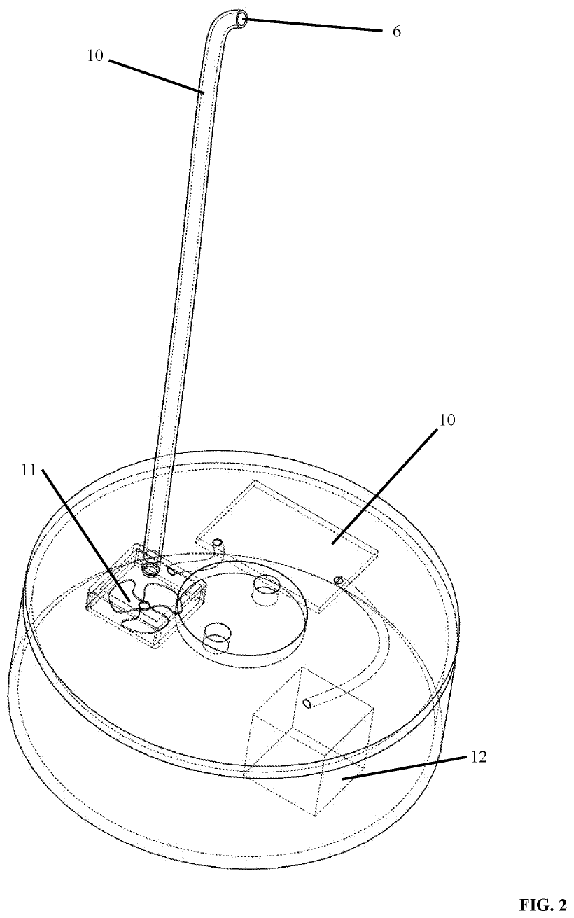

On the other hand, FIG. 2 provides a detailed view of the air flow system used to extinguish the flame in the automatic ignition and extinguishing candle, according to an embodiment of the present invention. The air flow system comprises an air hole (6), a fan (5), and an air tube (13), all of which work together under the control of the controller (10) to direct air towards the wick and extinguish the flame when necessary.

The air hole (6) is strategically positioned near the top of the candle body, directly above the wick. The air hole (6) may be fitted with a nozzle or a directional outlet to ensure that the air flow is precisely directed towards the flame for optimal extinguishing performance. The size and shape of the air hole (6) may vary depending on the size of the candle and the desired air flow characteristics.

Connected to the air hole (6) is an air tube (13), which is contained within the candle body. The air tube (13) may be a separate tube or a drilled hole within the candle body, designed to guide the air flow from the fan (5) to the air hole (6). The air tube (13) is positioned and shaped to minimize obstruction of the air flow and ensure efficient delivery of air to the wick.

At the base of the air tube (13) is the fan (5), which is responsible for generating the air flow necessary to extinguish the flame. The fan (5) is electrically connected to and controlled by the controller (10). When the controller (10) receives a signal to extinguish the flame, it activates the fan (5), which draws in air from the surrounding environment and forces it through the air tube (13) and out of the air hole (6) towards the wick.

The activation of the fan (5) may be triggered by various events, such as the sensor detecting that the candle body has fallen over, or a predetermined timer set by the user via the buttons on the candle base. In the case of a timer, the user can press a button to set a desired duration for the candle to burn, after which the controller (10) will automatically activate the fan (5) to extinguish the flame.

In some aspects, the controller (10) is programmed to regulate the speed and duration of the fan (5) operation to ensure complete and efficient extinguishing of the flame. The controller (10) may also monitor the status of the flame through temperature or light sensors, providing feedback to the user or adjusting the air flow accordingly.

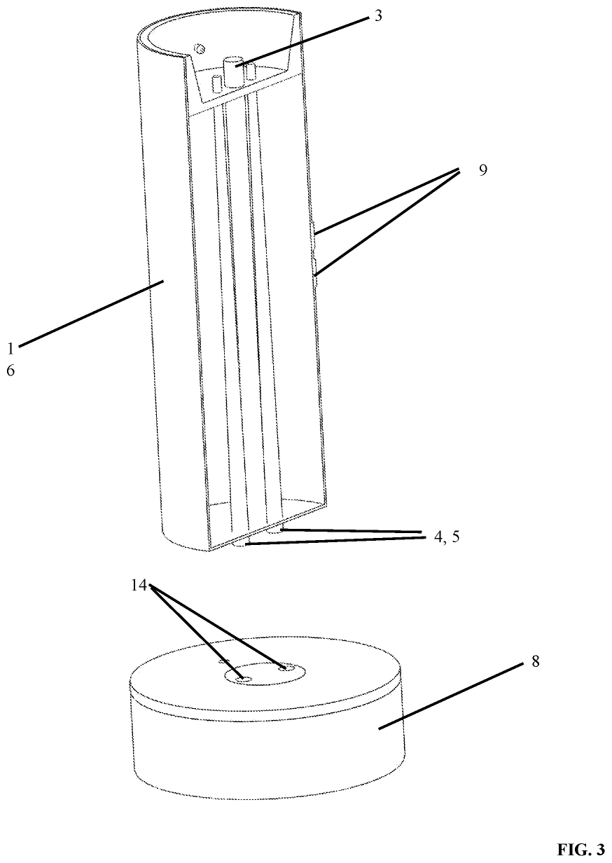

In a further aspect, the FIG. 3 illustrates an exploded view of a single wick automatic ignition and extinguishing candle system, according to an embodiment of the present invention. The disassembled candle system showcases the key components involved in the ignition process and how they interact with each other when the candle is in operation.

The main components of the ignition system are the first electrode (4) and the second electrode (5). These electrodes are positioned on either side of the wick and extend from the bottom of the candle wax to the top, where they protrude slightly above the surface of the wax. The upper portions of the electrodes (4, 5) are exposed, allowing for the generation of an electric arc between them when a power current is applied.

At the base of the candle, there is a sturdy and stable base (8) that provides support for the entire candle system. The base (8) is designed to hold the candle body securely in place and prevent it from tipping over during use. Integrated into the base (8) are electrode sockets (14), which are specifically designed to receive and hold the first electrode (4) and the second electrode (5) in their proper positions.

When the candle is assembled for operation, the first electrode (4) and the second electrode (5) are inserted into their respective electrode sockets (14) in the base (8). The electrode sockets (14) are connected to a power source within the base (8), such as a battery or a capacitor, which provides the necessary electrical current to generate the arc between the electrodes.

To ignite the wick, the user activates the candle system, typically by pressing a button or switch on the base (8). Upon activation, the power source within the base (8) sends an electrical current through the electrode sockets (14) and into the first electrode (4) and the second electrode (5). As the current flows through the electrodes, it creates a high-voltage electrical arc between the exposed tips of the electrodes, which are positioned directly above the wick.

The heat generated by the electrical arc is intense enough to ignite the wick, which then begins to burn steadily, melting the surrounding candle wax and providing light and ambiance.

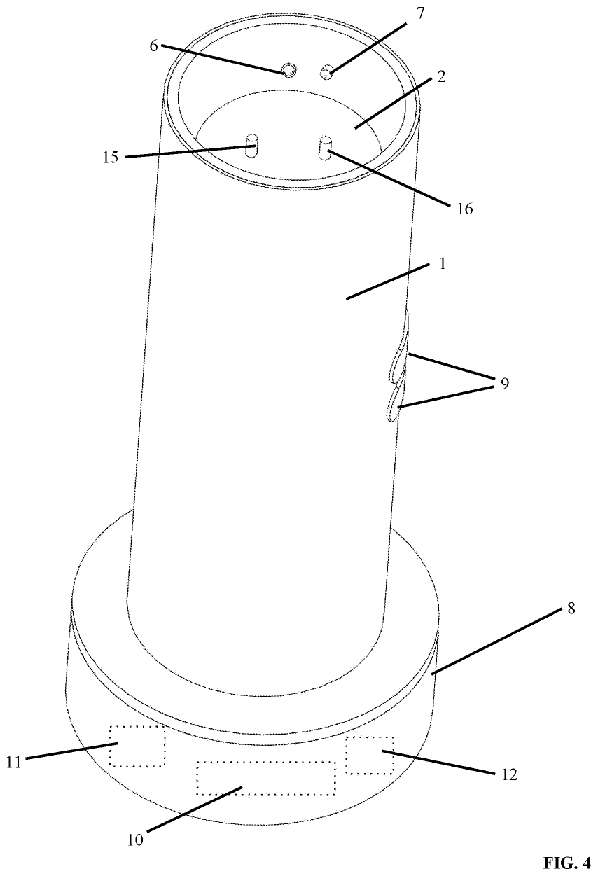

On the other hand, the FIG. 4 illustrates a perspective view of a double wick automatic ignition and extinguishing candle, according to another embodiment of the present invention. In this embodiment, the candle features two specially designed wicks that are coated with combustible and electrically conductive materials, allowing them to function as both the fuel source and the electrodes for self-ignition.

The candle comprises a candle body (1) that holds the candle wax (2) and the two wicks: the first wick (15) and the second wick (16). The candle body (1) is made of a heat-resistant material to ensure safety and durability during use. The first wick (15) and the second wick (16) are positioned parallel to each other and are embedded in the candle wax (2).

Both the first wick (15) and the second wick (16) are coated with a layer of combustible and electrically conductive materials. This coating allows the wicks to serve as electrodes, capable of conducting electricity and generating an electric arc between them when a current is passed through. The conductive coating material may be a thin layer of graphite or metal, such as copper or aluminum, or a conductive polymer that is safe for use in candles.

When the user activates the candle system using the buttons (9) on the base (8), the controller (10) sends a signal to initiate the ignition sequence. The battery (12) or other power source within the base (8) supplies an electrical current to the first wick (15) and the second wick (16). As the current flows through the conductive coating on the wicks, it creates a high-voltage electrical arc between the exposed tips of the wicks, which are positioned above the surface of the candle wax (2).

The heat generated by the electrical arc is sufficient to ignite the combustible coating on the wicks, which in turn ignites the wicks themselves. Once lit, the candle begins to burn steadily, melting the surrounding candle wax (2) and providing light and ambiance.

The candle body (1) also features an air hole (6) positioned near the top of the candle, above the wicks. The air hole (6) is connected to an air tube that runs through the candle body (1) and is connected to a fan (11) located in the base (8). When the candle needs to be extinguished, the controller (10) activates the fan (11), which forces air through the air tube and out of the air hole (6), directly onto the burning wicks, extinguishing the flame.

The activation of the fan (11) may be triggered by various events, such as a sensor (7) detecting motion or the presence of an object near the candle, or a predetermined timer set by the user via the buttons (9) on the base (8).

The base (8) houses the electronic components, including the controller (10), battery (12), and fan (11). The battery (12) may be rechargeable or disposable, or the candle may be powered through a wired connection.

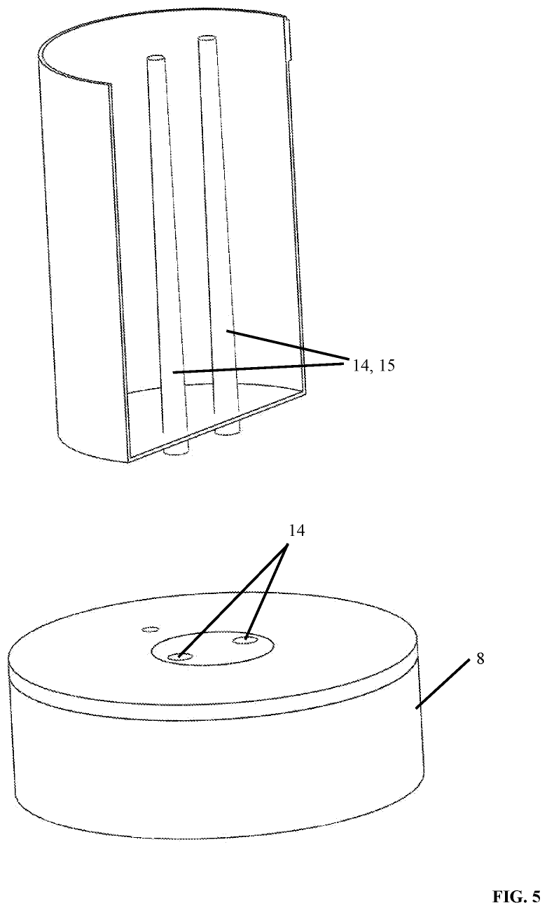

The FIG. 5 provides an exploded view of a double wick automatic ignition and extinguishing candle system, according to an embodiment of the present invention. This disassembled view showcases the key components of the double-wick candle system and how they interact with each other when the candle is assembled and in operation.

The main components of the ignition system in this double wick design are the first wick (15) and the second wick (16). Unlike traditional candle wicks, these wicks are specially designed to function as both the fuel source and the electrodes for self-ignition. The first wick (15) and the second wick (16) are coated with a layer of combustible and electrically conductive materials, such as a thin metal film or a conductive polymer.

At the base of the candle system, there is a sturdy and stable base (8) that provides support for the entire candle assembly. The base (8) is designed to hold the candle body securely in place, preventing it from tipping over during use. Integrated into the base (8) are electrode sockets (14), which are specifically designed to receive and hold the first wick (15) and the second wick (16) in their proper positions.

When the candle is assembled for operation, the first wick (15) and the second wick (16) are inserted into their respective electrode sockets (14) in the base (8). The electrode sockets (14) are connected to a power source within the base (8), such as a battery or a capacitor, which provides the necessary electrical current to generate the arc between the wicks.

To ignite the candle, the user activates the candle system, typically by pressing a button or switch on the base (8). Upon activation, the power source within the base (8) sends an electrical current through the electrode sockets (14) and into the first wick (15) and the second wick (16). As the current flows through the conductive coating on the wicks, it creates a high-voltage electrical arc between the exposed tips of the wicks, which are positioned above the surface of the candle wax.

The heat generated by the electrical arc is intense enough to ignite the combustible coating on the wicks, which in turn ignites the wicks themselves. The candle begins to burn steadily, melting the surrounding candle wax and providing light and ambiance.

In some aspects, the automatic ignition and extinguishing mechanism allows for easy operation, making it convenient for users to light and extinguish the candle as needed. The compact nature of the candle also makes it suitable for use in a variety of settings, from homes to offices and even outdoor environments.

In some aspects, the candle body and wicks can be made from various materials, such as soy wax, beeswax, or eco-friendly alternatives, depending on the desired aesthetic and performance characteristics. The conductive materials used in the wicks are carefully selected to ensure safe and efficient ignition and burning.

In other aspects, the present invention can be easily adapted to accommodate different types of candle sizes and fragrances. While the primary focus has been on traditional candle applications, the device can be used with various other candle-related products, such as scented wax melts, outdoor citronella candles, and even decorative candles. The versatility of the system makes it an attractive option for a wide range of consumers, from casual candle users to enthusiasts.

### INDUSTRIAL APPLICATION

The automatic ignition and extinguishing candle has a wide range of industrial applications. In the hospitality industry, it can be used in restaurants, hotels, and spas to create a warm and inviting ambiance while minimizing the risk of fire hazards. The candle's motion-activated extinguishing feature ensures safety in high-traffic areas. In the event planning sector, the candle can be employed to enhance the atmosphere at weddings, parties, and conferences, with the added convenience of remote ignition and timed extinguishing. The candle's adaptability to various sizes and fragrances makes it suitable for use in the candle manufacturing industry, catering to diverse consumer preferences.

What is claimed is:

1. An automatic ignition and extinguishing candle, comprising:
a candle body containing a wax fuel and a single wick;
an electric arc lighter comprising two electrodes positioned on either side of the wick;
a fan-based air blower positioned to direct an airflow at the wick; and
a motion sensor configured to detect motion near the candle and trigger the air blower to extinguish the candle flame in response to detected motion;
wherein the electric arc lighter is configured to ignite the wick to light the candle.

2. The automatic ignition and extinguishing candle of claim 1, wherein the motion sensor is an infrared motion sensor.

3. The automatic ignition and extinguishing candle of claim 1, wherein the motion sensor is an ultrasonic motion sensor.

4. The automatic ignition and extinguishing candle of claim 1, further comprising a microcontroller configured to control the operation of the electric arc lighter and the fan-based air blower.

5. The automatic ignition and extinguishing candle of claim 4, further comprising a button connected to the microcontroller, wherein the button is configured to manually initiate the ignition of the wick by the electric arc lighter.

6. The automatic ignition and extinguishing candle of claim 4, further comprising a timer connected to the microcontroller, wherein the timer is configured to automatically extinguish the candle flame after a preset time duration.

7. The automatic ignition and extinguishing candle of claim 1, wherein the electric arc lighter comprises a high-voltage generator connected to the two electrodes.

8. The automatic ignition and extinguishing candle of claim 1, wherein the fan-based air blower is positioned above the wick and angled downward towards the wick.

9. The automatic ignition and extinguishing candle of claim 1, further comprising a flame detector configured to detect the presence of a flame on the wick and send a signal to the microcontroller to confirm successful ignition or extinguishing of the candle.

10. An automatic ignition and extinguishing candle, comprising:
a candle body containing a wax fuel and two wicks, each wick comprising combustible and electrically conductive materials;
an electric arc generating circuit connected to the two wicks and configured to generate an arc between the wicks to ignite them;
a fan-based air blower positioned to direct an airflow at the wicks; and
a motion sensor configured to detect motion near the candle and trigger the air blower to extinguish the candle flames in response to detected motion.

11. The automatic ignition and extinguishing candle of claim 10, wherein each wick comprises a combustible cotton core coated with a conductive material.

12. The automatic ignition and extinguishing candle of claim 11, wherein the conductive material is graphene.

13. The automatic ignition and extinguishing candle of claim 10, wherein the electric arc generating circuit comprises a battery, a capacitor, and a switch configured to discharge the capacitor across the two wicks.

14. The automatic ignition and extinguishing candle of claim 10, further comprising a microcontroller configured to control the operation of the electric arc generating circuit and the fan-based air blower.

15. The automatic ignition and extinguishing candle of claim 14, further comprising a remote control receiver connected to the microcontroller, wherein the remote control receiver is configured to receive signals from a remote control device to initiate ignition or extinguishing of the candle.

16. The automatic ignition and extinguishing candle of claim 10, wherein the motion sensor is a passive infrared (PIR) motion sensor.

17. The automatic ignition and extinguishing candle of claim 11, further comprising a sound-activated switch configured to initiate ignition of the candle in response to a sound exceeding a preset threshold.

18. The automatic ignition and extinguishing candle of claim 10, further comprising a light sensor configured to detect ambient light levels and initiate ignition of the candle when ambient light falls below a preset threshold.
